(19) United States
(12) Patent Application Publication
(10) Pub. No.: US 2026/0122152 A1
(43) Pub. Date: Apr. 30, 2026

(54) LOCAL EXCEPTION TRAFFIC OFFLOAD

(71) Applicant: Arista Networks, Inc., Santa Clara, CA (US)

(72) Inventors: Kevin Martin Amiraux, San Jose, CA (US); Sean Hope, North Vancouber (CA)

(21) Appl. No.: 19/003,828

(22) Filed: Dec. 27, 2024

Related U.S. Application Data
(60) Provisional application No. 63/700,014, filed on Sep. 27, 2024.

(51) Int. Cl. H04L 69/167; H04L 47/19; H04L 47/36; H04L 47/43

(52) U.S. Cl. CPC H04L 69/167; H04L 47/19; H04L 47/36; H04L 47/43

(57) ABSTRACT

A network device comprises interfaces, a forwarding chip for switching and forwarding network traffic, and central processing unit (CPU). The forwarding chip offloads exceptions to the local CPU. The local CPU executes a software forwarding engine (SFE) to process exception traffic offloaded by the forwarding chip to generate processed exception traffic and returns the processed exception traffic to the forwarding chip for forwarding.

### RELATED APPLICATIONS

This application claims the benefit of priority under 35 U.S.C. 119(e) to U.S. Provisional Application No. 63/700,014, entitled “MAP-T Local Exception Traffic Offload,” filed Sep. 27, 2024, which is hereby fully incorporated by reference herein.

### TECHNICAL FIELD

The present disclosure relates to exception traffic handling in a network device. Even more particularly, the present disclosure relates to handling of MAP-T exceptions in a network device.

### BACKGROUND

In some network devices, translation and forwarding of traffic is implemented by a specialized forwarding chip (e.g., an application specific integrated circuit (ASIC)) designed for routing and switching of packets. However, there may be some types of traffic that cannot be handled by the forwarding chip (exception traffic), resulting in dropped packets and other deleterious effects.

Mapping of Address and Port using Translation (MAP-T) described in Li et al., 2015. “Mapping of Address and Port using Translation (MAP-T), RFC 7599, Internet Engineering Task Force (https://www.rfc-editor.org/rfc/rfc7599.html) (RFC 7599) specifies a solution for providing shared or non-shared Internet Protocol version 4 (IPv4) address connectivity.

In the overall MAP-T architecture, a MAP domain is one or more MAP Customer Edges (CEs) and border relays (BRs) connected by an Internet Protocol version 6 (IPv6) network and sharing a common set of MAP rules. A border relay or “BR” is a MAP-enabled router that routes traffic between an IPv6 network and an IPv4 network. There are existing implementations of MAP that use forwarding chips. Most forwarding chips, however, cannot handle all the packet types involved in MAP-T translation. This is most common for ISPs using some sort of IPv4 sharing scheme. The typical solution when the forwarding chip detects cases that it cannot handle is to either drop the packets or forward packets to an external offload device.

### BRIEF DESCRIPTION OF DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1 is a diagrammatic representation of one embodiment of network device with local exception offloading;

FIG. 2 is a diagrammatic representation of an example of a Mapping of Address and Port using Translation (MAP-T) deployment;

FIG. 3 is a diagrammatic representation of one embodiment of network device with local MAP-T exception offloading;

FIG. 4 is a diagrammatic representation of one embodiment of a software forwarding engine;

FIG. 5 is a flow chart illustrating one embodiment of a method for handling a maximum transmission unit (MTU) violation after translation;

FIG. 6 is a flow chart illustrating one embodiment of a method for handling a fragment exception.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

As discussed, a network device may contain a forwarding chip that cannot handle certain traffic that it receives. For example, a forwarding chip of a mapping of address and port (MAP) enabled router may be unable to handle certain packet types. According to embodiments of the present disclosure, the forwarding chip is configured to offload at least some exception traffic to a central processing unit (CPU). The CPU implements a software-based forwarding engine to handle the exception traffic and return the exception traffic to the forwarding chip.

A typical MAP deployment includes one or more MAP enabled customer edges (CEs) and MAP border relays (BRs) connected by an IPv6 network. Each MAP customer edge (CE) in the deployment is a MAP-enabled router that includes an IPv6 addressed interface (e.g., an IPv6 addressed wide area network (WAN) interface) connected to the IPv6 network and one or more interfaces (e.g., local area network (LAN) interfaces) addressed using private Internet Protocol version 4 (IPv4) addressing for a private IPv4 network. Each border relay (BR) is a MAP-enabled router that includes at least an Internet Protocol version 6 (IPv6)-enabled interface connected to the IPv6 network and an IPv4 interface connected to a native IPv4 network, such as a public IPv4 network.

Each MAP-enabled CE and BR of a MAP deployment implements a MAP rule set that includes one or more MAP rules. In MAP-T there are three types of MAP rules: basic mapping rule (BMR), forwarding mapping rule (FMR), and default mapping rule (DMR). A BMR can be used by a CE to provision itself with an IPv4 prefix, IPv4 address, or shared IPv4 address and port set. A BMR includes a rule IPv6 prefix, a rule IPv4 prefix, a rule embedded address (EA) bit length. An FMR is used for forwarding IPv4 and IPv6 within a MAP-T domain and includes the same parameters as a BMR: a rule IPv6 prefix, a rule IPv4 prefix, a rule embedded address (EA) bit length. In some embodiments, a BMR or FMR may include rule port parameters, such as a port set id (PSID) length or a PSID offset. A DMR is a rule for mapping IPv4 information to IPv6 addresses for destinations outside a MAP domain (e.g., for forwarding traffic outside of a MAP domain).

A MAP deployment may include one or more MAP domains where each MAP domain is one or more MAP CEs and BRs connected by an IPv6 network and sharing a common set of MAP rules. In some implementations, each MAP CE and MAP BR in a MAP domain that implements MAP-T includes the same MAP-T configuration. Examples of MAP-T configuration parameters include a basic mapping rule (BMR) for the MAP domain, a MAP BR's IPv6 prefix used in a default mapping rule (DMR), forwarding mapping rules (FMRs), a parameter to indicate that IPv4-IPv6 translation is enabled, and a parameter to indicate a communication mode (e.g., a “hub-and-spoke” in which all traffic sent by a CE in the domain is forwarded via a BR or a “mesh” mode whereby CEs in a domain are able to directly forward traffic to other CEs in the domain).

In a typical MAP-T enabled router implementation, the IPv4-to-IPv6 (“4to6”) translation and IPv6-to-IPv4 (“6to4”) translation and forwarding of traffic is implemented by a specialized forwarding chip (e.g., an application specific integrated circuit (ASIC)) designed for routing and switching of packets. However, there may be some types of traffic (exception traffic) that cannot be handled by the forwarding chip. According to embodiments of the present disclosure, one or more MAP-T enabled routers (e.g., one or more MAP CEs or MAP BRs) in a MAP-T deployment includes a forwarding chip that supports local exception handling whereby the forwarding chip offloads MAP-T exception traffic to a local supervisor CPU that implements a software pipeline for handling the small portion of the traffic that isn't fully handled by the forwarding chip.

Even more particularly, one embodiment of a network device includes a local CPU, a plurality of interfaces, including at least one IPv4 interface and at least one IPv6 interface, a forwarding chip connected to the plurality of interfaces and the CPU and a memory. The forwarding chip is MAP-T enabled and configured to offload MAP-T exception traffic to the local CPU. The memory includes stored software instructions for a software forwarding engine (SFE) that is executable by the local CPU to process MAP-T exception traffic offloaded by the forwarding chip to generate processed MAP-T exception traffic and return the processed MAP-T exception traffic to the forwarding chip for forwarding. The SFE and forwarding chip may include the same MAP rules and routes. In one embodiment, the forwarding chip is an application specific integrated circuit (ASIC) for routing and switching of packets.

One embodiment of processing the MAP-T exception traffic offloaded by the forwarding chip includes receiving an IP packet according to a first IP version, determining that the IP packet matches a MAP rule for a MAP domain, determining to fragment the IP packet, where determining to fragment the IP packet comprises determining that a translated packet size of the IP packet when translated to a second IP version exceeds a maximum transmission unit (MTU) threshold, generating a plurality of fragments according to the second IP version, where generating the plurality of fragments according to the second IP version comprises fragmenting the IP packet, and determining next hop information for the plurality of fragments. Returning the processed MAP-T exception traffic to the forwarding chip for forwarding includes returning the plurality of fragments and the next hop information to the forwarding chip. In one embodiment of generating the plurality of fragments according to the second IP version, the IP packet according to the first IP version is fragmented and the fragments translated to the second IP version according to the MAP rule. In another embodiment, the IP packet is translated according to the MAP rule and the translated IP packet is fragmented.

Another embodiment of processing the MAP-T exception traffic offloaded by the forwarding chip includes receiving a plurality of fragments, assembling the plurality of fragments into an assembled IP packet according to a first IP version, translating the assembled IP packet to a second IP version according to a MAP rule and determining next hop information for the IP packet. Returning the processed MAP-T exception traffic to the forwarding chip includes returning the IP packet as translated to the second IP version and the next hop information to the forwarding chip.

Another embodiment of processing the MAP-T exception traffic offloaded by the forwarding chip includes receiving a plurality of fragments; assembling the plurality of fragments into an Internet Protocol (IP) packet according to a first IP version, determining to fragment the IP packet, where determining to fragment the IP packet includes determining that a translated packet size of the IP packet when translated to a second IP version exceeds an MTU threshold, generating a second plurality of fragments according to the second IP version, where generating the second plurality of fragments according to the second IP version comprises fragmenting the IP packet, and determining next hop information for the second plurality of fragments. Returning the processed MAP-T exception traffic to the forwarding chip for forwarding comprises returning the second plurality of fragments and the next hop information to the forwarding chip. In one embodiment of generating the plurality of fragments according to the second IP version, the assembled IP packet according to the first IP version is fragmented and the resulting fragments are translated according to the MAP rule. In another embodiment, the IP packet as translated according to the MAP rule is fragmented to generate the plurality of fragments.

Another embodiment of processing the MAP-T exception traffic offloaded by the forwarding chip includes receiving an IP packet according to a first IP version, where the IP packet encapsulates a protocol not supported by the forwarding chip, translating the IP packet to a second IP version, including translating the encapsulated protocol, and determining next hop information for the IP packet. Returning the processed MAP-T exception traffic to the forwarding chip for forwarding comprises returning the IP packet as translated to the second IP version and the next hop information to the forwarding chip.

Another example embodiment of processing the MAP-T exception traffic offloaded by the forwarding chip includes receiving an IP packet according to a first IP version and encapsulating a UDP protocol with a UDP checksum of 0, recalculating the UDP checksum to generate a recalculated UDP checksum, and translating the IP packet to a second IP version according to a MAP rule where the IP packet as translated to the second IP version includes the recalculated UDP checksum. Processing the MAP-T exception traffic offloaded by the forwarding chip may further include determining next hop information for the IP packet. Returning the processed MAP-T exception traffic to the forwarding chip for forwarding comprises returning the IP packet as translated to the second IP version and the next hop information to the forwarding chip.

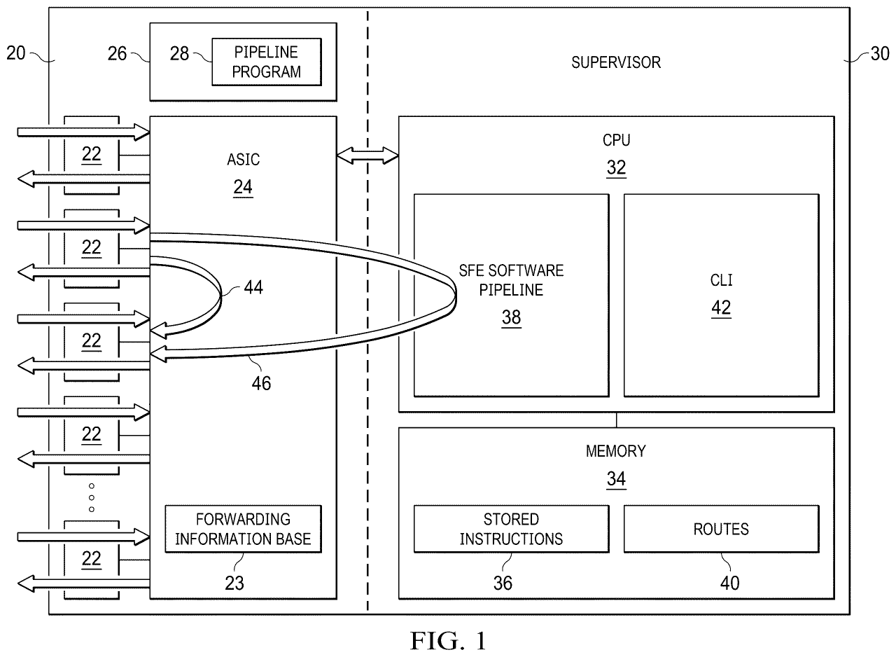

FIG. 1 is a diagrammatic representation of a general architecture of one embodiment of network device 20 that implements local exception offloading. Network device 20 comprises a plurality of network interfaces 22 (also referred to as ports) and a forwarding chip 24 connected to interfaces 22. Forwarding chip 24 implements a forwarding pipeline to forward packets The forwarding pipeline implements various tables, such as a forwarding information base 23, for forwarding packets and performing other operations. According to one embodiment, the forwarding pipeline matches data bits in packets against tables, such as forwarding information base 23, to forward packets.

In one embodiment, forwarding chip 24 is a programmable switching ASIC that supports data plane programmability. By way of example, but not limitation, forwarding chip 24, in one embodiment, is an Intel® Tofino™ Ethernet switch ASIC (Intel® and Tofino™ belong to the registered owners of the marks and no claim is made herein to ownership of these marks). Accordingly, network device 20 includes memory 26 storing a pipeline program 28 that can be compiled and used to configure forwarding chip 24 to implement forwarding pipeline as defined in the pipeline program 28. As but one example, P4 is a language for expressing how packets are to be processed by the data plane of a programmable network device.

Pipeline program 28 is adapted to configure stages of the ingress portion and egress portion of the forwarding pipeline. Pipeline program 28 can be compiled and used to configure forwarding chip 24 to implement the forwarding pipeline as defined in pipeline program 26.

Network device 20 further includes a supervisor module 30 having a central processing unit (CPU) 32 connected to other components such as memory 34 and forwarding chip 24 by an internal bus system. In one embodiment, CPU 32 connects to forwarding chip 24 by a high-speed bus, such as a peripheral component interconnect express (PCIe) bus.

Memory 34 includes stored instructions 36, which may include instructions for a variety of software programs, such as, but not limited to a network operating system, which is a specialized operating system for a network device (e.g., router, switch, firewall, and the like). For example, the network operating system may be Arista Extensible Operating System) (EOS®), which is a fully programmable and highly modular, Linux-based network operating system. Other network operating systems may be used.

In particular, stored instructions 36 include instructions executable by CPU 32 to implement a software forwarding engine (SFE) 38. According to one embodiment, SFE 38 is implemented using hardware accelerated CPU functionality to perform high performance stateless packet processing. By way of example, but not limitation, SFE 38, according to one embodiment, is instantiated based on a Berkeley Extensible Software Switch (BESS)/Data Plane Development Kit (DPDK) environment. SFE 38 is programmed with routes 40 (e.g., a routing table or forwarding table) and other data used by SFE 38. In one embodiment, routes 40 includes the same routes as forwarding chip 24.

According to one embodiment, stored instructions 36 are executable by CPU 32 to provide an interface, such as command line interface (CLI) 42. Through the interface, a user can specify if offloading exceptions to the CPU is enabled. The interface can be used to configure the rules used by SFE 38

Forwarding chip 24 is configured to offload certain types of traffic that it cannot handle to local CPU 32 (exception traffic). The type of traffic offloaded depends on implementation. In any case, when forwarding chip 24 processes packets that meet the rules for offloading packets with which forwarding chip 24 is configured (e.g., as part of pipeline program 28 or otherwise), forwarding chip 24 offloads the packet to CPU 32. Packets may be identified as exceptions based on field values from the packet (individual field values or combinations of field values), the presence or absence of certain field values, or other information that may be derived from the packet and rules applied thereto. By way of example, but not limitation, a packet may be identified as an exception based on one or more of the packet size, whether the packet is fragment, the packet checksum, or a protocol encapsulated in the packet. If forwarding chip 24 receives exception traffic that it is not configured to offload, forwarding chip 24 may drop the traffic or take another predefined exception action depending on implementation.

In a regular (non-exception) traffic flow 44 from an ingress interface 22 to an egress interface 22, network device 20 receives a packet through an interface 22 and forwards the packet to forwarding chip 24 for processing. Based on a determination that the packet is not an exception to be offloaded to local CPU 32, forwarding chip 24 continues to process the packet according to the regular traffic flow. Forwarding chip 24 performs various operations on the packet based on the pipeline implemented by forwarding chip 24 and forwards the packet to a second interface 22 according to forwarding information base 23.

In an exception traffic flow 46 from an ingress interface 22 to an egress interface 22, network device 20 receives a packet through an interface 22 and forwards the packet to forwarding chip 24 for processing. Based on a determination that the packet is an exception to be offloaded to local CPU 32, forwarding chip 24 forwards the packet to CPU 32, which runs SFE 38 and is programmed to handle the offloaded exception traffic. SFE 38 performs the processing with which the pipeline is configured, including, but not limited to, exception processing and routing and sends the packet back to forwarding chip 24, which forwards the packet to a destination over the appropriate interface 22.

While only one forwarding chip 24 and CPU 32 are illustrated in FIG. 1, a network device with exception offload can include multiple CPUs and forwarding chips capable of participating in local exception offloading. Furthermore, in some embodiments, exception offloading to CPU 32 can be enabled/disabled, such as through a configuration setting. Moreover, in some embodiments, specific exceptions can be enabled or disabled for offload exception handling. For example, an administrator may individually enable/disable one or more types of exception offloading.

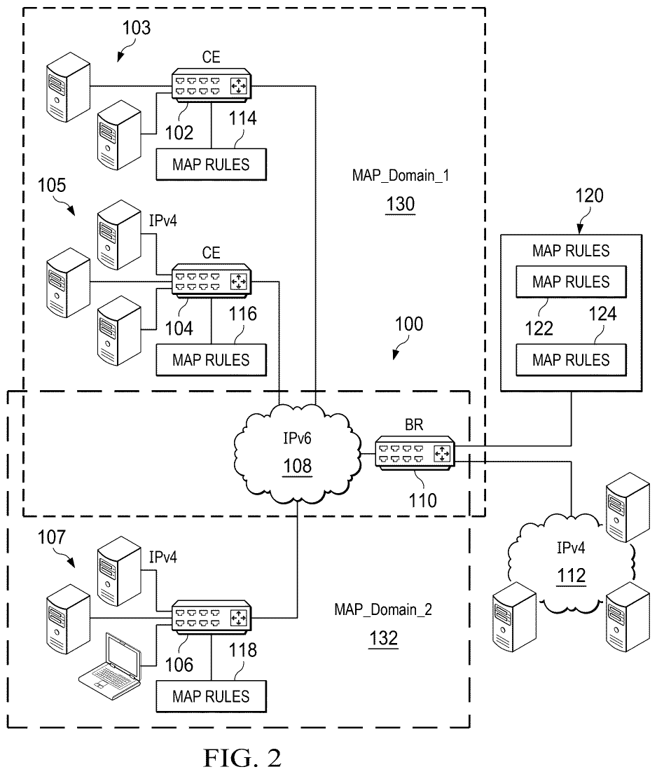

In one example embodiment, the forwarding chip of a network device is configured to offload MAP-T exception traffic. To provide additional context, FIG. 2 is a diagrammatic representation of one embodiment of a (MAP-T) network 100 that includes CE 102 connected between IPv4 endpoints 103 and IPv6 network 108, CE 104 connected between IPv4 endpoints 105 and IPv6 network 108, CE 106 connected between IPv4 endpoints 107 and IPv6 network 108, and BR 110 connected to IPv6 network 108 and IPv4 network 112. Each CE includes an IPv6 addressed interface connected to IPv6 network 108 and privately addressed IPv4 interfaces connected to IPv4 endpoints and is responsible for mapping between a private IPv4 address space and an IPv6 address space. BR 110 includes an IPv6 interface connected to IPv6 network 108 and an IPv4 interface connected to IPv4 network 112. In one example deployment, BR 110 is managed by a service provider and acts as an edge node between IPv6 network 108 and a public IPv4 network 112 whereas the CEs provide access points for private IPv4 users.

Each MAP-enabled router in MAP-T network 100 implements a MAP rule set that includes one or more MAP rules. In FIG. 2, CE 102 implements MAP rule set 114, CE 104 implements MAP rule set 116, CE 106 implements MAP rule set 118, and BR 110 implements MAP rule set 120. Network 100 includes MAP-T domain 130 (“MAP_Domain_1”) and MAP-T domain 132 (“MAP_Domain_2”). In this example, MAP rule set 114, MAP rule set 116, and MAP rule set 122 include a common set of MAP rules for MAP_Domain_1 whereas MAP rule set 118 and MAP rule set 124 include a common set of MAP rules for MAP_Domain_2. According to one embodiment, each MAP rule set includes a BMR and a DMR for a MAP domain. In some embodiments, a MAP rule set also includes one or more FMRs.

According to one embodiment, one or more MAP-T enabled routers in a MAP-T deployment includes one or more forwarding chips that offload MAP-T exception traffic to one or more local supervisor CPUs. In even more particular embodiments, one or more BRs offload MAP-T exception traffic to one or more local supervisor CPUs.

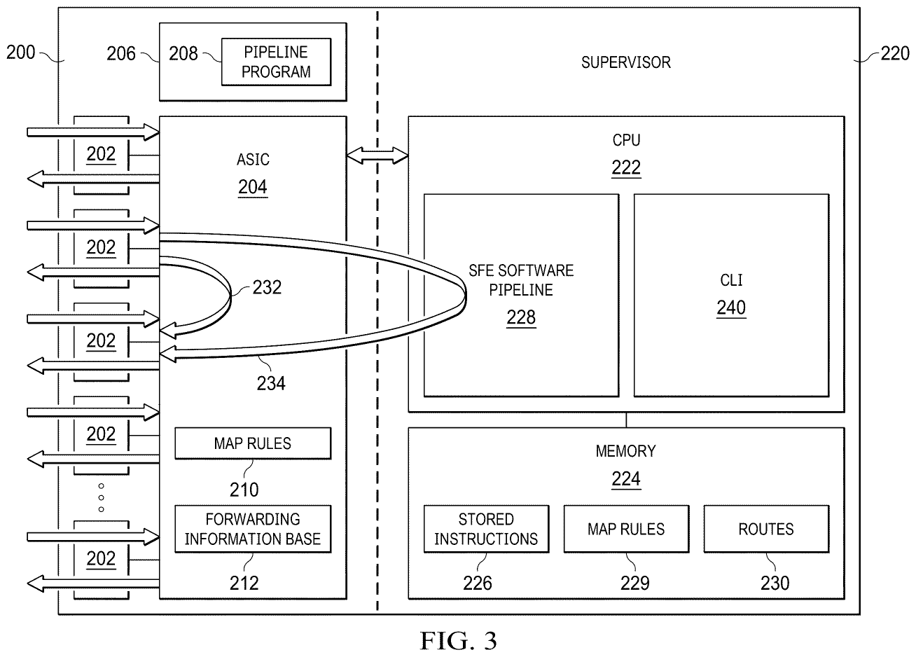

FIG. 3 is a diagrammatic representation of a general architecture of one embodiment of network device 200 for MAP-T traffic handling. Network device 200 comprises a plurality of network interfaces 202 (also referred to as ports). At least one of the interfaces 202 is an IPv6 addressed interface and at least one of the interfaces 202 is an IPv4 addressed interface. In a MAP BR, for example, at least one interface 202 connects to an IPv6 network (e.g., network 108) and at least one interface connects to an IPv4 network (e.g., network 112) and, in an even more particular embodiment, a public IPv4 network.

Network device 200 includes a forwarding chip 204 connected to interfaces 202. Forwarding chip 204 implements a forwarding pipeline that performs 4to6 and 6to4 translation and packet forwarding. The forwarding pipeline implements various tables such as a MAP rule table 210 embodying MAP rules for one or more MAP domains and forwarding information base 212 for forwarding packets. According to one embodiment, the forwarding pipeline matches data bits in packets against tables, such as a MAP rule table 210 to perform 4to6 and 6to4 translation and forwarding information base 212 to forward packets. As will be appreciated, MAP-T 4to6 translation includes translating IPv4 source address to an IPv6 source address and an IPv4 destination address to an IPv6 destination address including a PSID, and 6to4 translation includes translating the IPv6 source address to an IPv4 source address and an IPv6 destination address and PSID to an IPv4 destination address. Translating from IPv4 to IPv6 according to MAP rules is known to those skilled in the art and thus is not further described herein.

In one embodiment, forwarding chip 204 is a programmable switching ASIC that supports data plane programmability. By way of example, but not limitation, forwarding chip 204, in one embodiment, is an Intel® Tofino™ Ethernet switch ASIC (Intel® and Tofino™ belong to the registered owners of the marks and no claim is made herein to ownership of these marks). Accordingly, network device 200 includes memory 206 storing a pipeline program 208 that can be compiled and used to configure forwarding chip 204 to implement forwarding pipeline as defined in the pipeline program 208. As but one example, P4 is a language for expressing how packets are to be processed by the data plane of a programmable network device.

Pipeline program 208 is adapted to configure stages of the ingress portion and egress portion of the forwarding pipeline. Pipeline program 208 can be compiled and used to configure forwarding chip 204 to implement the forwarding pipeline as defined in pipeline program 206.

Network device 200 further includes a supervisor module 220 having a central processing unit (CPU) 222 connected to other components such as memory 224 and forwarding chip 204 by an internal bus system. In one embodiment, CPU 222 connects to forwarding chip 204 by a high-speed bus, such as a peripheral component interconnect express (PCIe) bus.

Memory 224 includes stored instructions 226, which may include instructions for a variety of software programs, such as, but not limited to a network operating system, which is a specialized operating system for a network device (e.g., router, switch, firewall, and the like). For example, the network operating system may be Arista Extensible Operating System) (EOS®), which is a fully programmable and highly modular, Linux-based network operating system. Other network operating systems may be used.

In particular, stored instructions 226 include instructions executable by CPU 222 to implement a software forwarding engine (SFE) 228, which is programmed with MAP rule set 229 for one or more MAP domains and routes 230 (e.g., a routing table or forwarding table). MAP rule set 229 includes the same MAP rules as forwarding chip 204 and routes 230 includes the same routes as forwarding chip 204. According to one embodiment, SFE 228 is implemented using hardware accelerated CPU functionality to perform high performance stateless packet processing. by way of example, but not limitation, SFE 228, according to one embodiment, is instantiated based on a Berkeley Extensible Software Switch (BESS)/Data Plane Development Kit (DPDK) environment.

According to one embodiment, stored instructions 226 are executable by CPU 222 to provide an interface, such as command line interface (CLI) 240. Through the interface, a user can specify if offloading MAP-T exceptions to the CPU is enabled. The interface can be used to configure MAP-T details, such as domains and MAP rules for translating between domains.

Forwarding chip 204 is configured to offload certain types of traffic that it cannot handle to local CPU 222 (exception traffic). The following exceptions are used as examples herein: unsupported protocol traffic, IPv4 fragments, maximum transmission unit (MTU) violation in translation (packet size of translated packet exceeds MTU threshold), and IPv4 UDP packets with checksum 0. However, the types of traffic that cause exceptions that can be offloaded to the local CPU depend on implementation. If forwarding chip 204 receives exception traffic that it is not configured to offload, forwarding chip 204 may drop the traffic or take another predefined exception action depending on implementation.

Determining the protocol (TCP, UDP, etc.), checksum, and whether a packet is a fragment is known to those skilled in the art and thus is not further described herein. With MTU violation in translation, network device 200 may be configured with one or more MTU thresholds (e.g., an MTU threshold for an IPv6 network, an MTU threshold for an IPv4 network, IPv6 or IPv4 thresholds per MAP domain). According to one embodiment, network device 200 performs path MTU discovery (PMTUD) to determine the MTUs of paths in one or more of the networks to which it is connected and can, therefore, set the minimum path MTUs as a threshold for fragmenting. In addition, or in the alternative, network device 200 provides a configuration function for the network administrator to set MTU thresholds to values that, for example, reflect the real values of the minimum MTUs in the networks or domains. In one embodiment, since MTU violations in translations are only likely to occur in the 4To6 direction due to the IPv4 header being smaller than the IPv6 header, network device 200 is only configured with an MTU threshold for the IPv6 network (or, in some embodiments, IPv6 MTU thresholds per MAP domain).

When network device 200 receives a packet through an interface 202, the packet is forwarded to forwarding chip 204 for processing. Forwarding chip 204 processes the packet to determine if the packet is exception traffic. For a packet to be translated according to a MAP rule, forwarding chip 204 determines if the packet will result in an MTU violation in translation by exceeding an MTU threshold. In one embodiment, forwarding chip 204 determines a predicted packet size after translation by adding a set number of bytes to the packet length of the packet as received. In another embodiment, forwarding chip 204 translates the packet to determine the actual packet size after translation. If the packet size after translation (predicted or actual) exceeds the MTU threshold, the packet is identified as an exception. In one embodiment, forwarding chip 204 only checks for MTU violations in translation in the 4To6 direction.

If the packet is not an exception, the packet follows a regular traffic flow. In a regular (non-exception) MAP-T traffic flow 232 from an ingress interface 202 to an egress interface 202, network device 200 receives a packet through an interface 202 and forwards the packet to forwarding chip 204 for processing. Based on a determination that the packet is not an exception to be offloaded to local CPU 222, forwarding chip 204 continues to process the packet according to the regular traffic flow. Forwarding chip 204 performs a MAP-T translation if the packet meets a MAP-T rule in MAP rule table 210 (e.g., based on a longest prefix match) and forwards the packet to a second interface 202 according to forwarding table 212. If the ingress interface 202 is an IPv4 addressed interface and egress interface 202 is an IPv6 addressed interface, forwarding chip 204 performs a 4to6 translation. If the ingress interface 202 is an IPv6 addressed interface and the egress interface 202 is an IPv4 addressed interface, forwarding chip 204 performs a 6to4 translation. If the packet does not match a MAP-T rule, forwarding chip 204 does not translate the packet (e.g., for a traffic flow between two IPv4 interfaces or between two IPv6 interfaces).

In an exception MAP-T traffic flow 234 from an ingress interface 202 to an egress interface 202, network device 200 receives a packet through an interface 202 and forwards the packet to forwarding chip 204 for processing. Based on a determination that the packet is an exception to be offloaded to local CPU 222, forwarding chip 204 forwards the packet to CPU 222, which runs SFE 228 and is programmed with the same MAP rules and routes as forwarding chip 204. SFE 228 performs 4to6 and 6to4 translation, depending on the direction of traffic, exception processing, and routing and sends the packet back to forwarding chip 204, which forwards the packet to a destination over the appropriate interface 202.

While only one forwarding chip 204 and CPU 222 are illustrated in FIG. 3, a network device with local MAP-T exception offload can include multiple CPUs and forwarding chips capable of participating in local MAP-T exception offloading. Furthermore, in some embodiments, MAP-T exception offloading to CPU 222 can be enabled/disabled, such as through a configuration setting. Moreover, in some embodiments, specific exceptions can be enabled or disabled for offload exception handling. For example, an administrator may individually enable/disable one or more of MTU violation on translation exception offloading, non-supported protocol exception offloading, UDP checksum 0 exception offloading, IPv4 fragment exception offloading, IPv6 fragment exception offloading or other exception offloading. Furthermore, MAP-T exceptions are just one example of exceptions that may be offloaded in various embodiments.

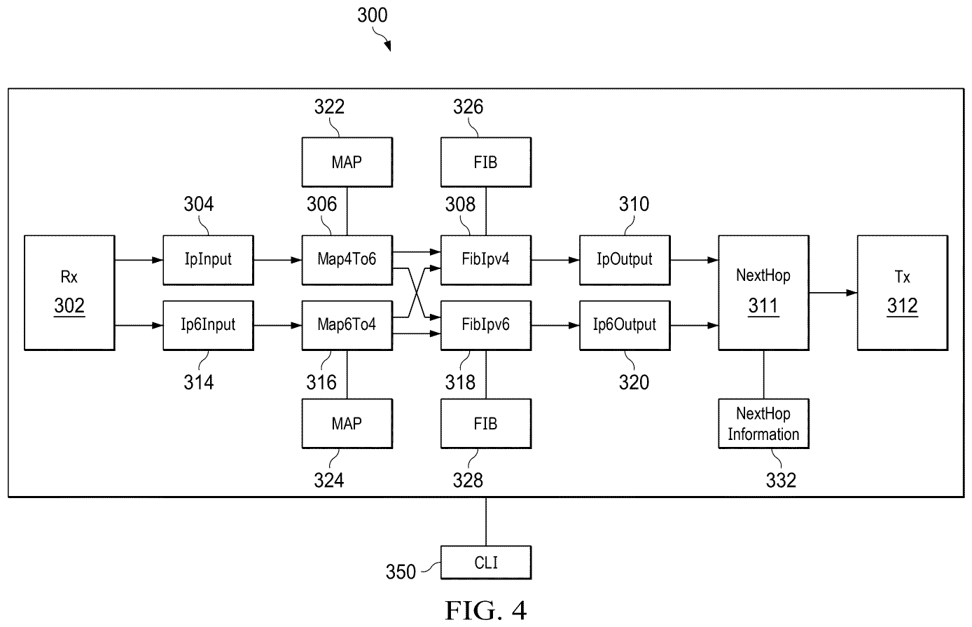

FIG. 4 is a diagrammatic representation of one embodiment of an SFE 300 that comprises a plurality of processing modules. A packet is processed by a pipeline of SFE modules connected in series, where the output of one SFE module is the input of the next SFE module in the pipeline. The processing modules of SFE 300 include receiver (Rx) module 302, IpInput module 304, Map4to6 module 306, FibIPv4 module 308, IPOutput module 310, nexthop module 311, transmit (Tx) module 312, Map6to4 module 316, FibIPv6 module 318, IPOutput module 320.

Map4to6 306 module is programmed with MAP rule set 322 and Map6to4 module 316 is programmed with MAP rule set 324, which may be the same as MAP rule set 322 in some embodiments. MAP rule set 322 and MAP rule set 324 can include the same MAP rules as the forwarding chip that offloads to SFE 300. FibIPv4 module 308 is programmed with FIB 326 and FibIPv6 module 318 is programmed with FIB 328, which may be the same as FIB 326 in some embodiments. NextHop module 311 is programmed with next hop information 332, such as the media access control (MAC) addresses for next hops. According to one embodiment, SFE 300 includes the same MAP rules and routing information as a local forwarding chip.

According to one embodiment, the supervisor unit of the network device includes software executable by the CPU to provide an interface, such as command line interface (CLI) 350. Through the interface, a user can specify if offloading MAP-T exceptions to the CPU is enabled. The interface can be used to configure MAP-T details, such as domains and MAP rule sets for the MAP domains.

According to one embodiment, the local CPU receives exception packets using PCIe. The CPU runs SFE 300 and is programmed with MAP-T rules and routes. The exception packets are thus processed using a software pipeline. Depending on the direction of the traffic, the packets in the software pipeline go to a Map4to6 module 306 or Map6to4 module 316. Routing is performed in FibIPv4 module 308 or FibIPv6 module 318 and the packets are sent back to the forwarding chip so that they can be sent to their final destination.

More particularly, Rx module 302 reads the packet from the forwarding chip (e.g., off a NIC). Determines if the traffic is IPv4 or IPv6 and forwards the traffic to the next module. If the packet is an IPv4 packet, Rx module 302 outputs the packet to IpInput module 304. If the packet is an IPv6 packet, Rx module 302 outputs the packet to Ip6Input module 314.

For IPv4 packets, IpInput module 304 performs packet validation checks to confirm that IPv4 packets can be handled by the pipeline and outputs the IPv4 packet to Map4to6 module 306. Similarly, Ip6Input module 314 performs packet validation checks to confirm that IPv6 packets can be handled by the pipeline and outputs the IPv6 packets to Map6to4 module 316. For example, IpInput module 304 and Ip6Input module 314 may validate checksums, check packet sizes, etc.

For an IPv4 packet, Map4to6 module 306 determines if the packet meets a MAP rule (e.g., a MAP rule in MAP rule set 322) and performs mapping according to the rule. MAP rules are accessed via a longest prefix match (LPM) lookup. If the lookup results in a hit, the IPv4 packet is translated to IPv6 according to the MAP rule and output to FibIpv6 module 318 for the IPv6 routing lookup according to FIB 328. If the packet does not meet a MAP rule, Map4to6 module 306 outputs it to FibIPv4 module 308 for a routing lookup according to FIB 326. In the 4to6 direction the packet size will grow by 20 bytes, and the packet may now exceed the MAP domain MTU. If so, the packet can be fragmented. IpOutput module 310 handles IPv4 packet header rewrites for IPv4 packets, such as computing checksums, performing DSCP rewrites, or other packet header rewrites.

In the 6to4 direction, an IPv6 packet undergoes MAP processing if its destination address matches the border relay prefix configured for one of the MAP domains. The border relay prefixes are either /96's, /64's, or /32's. According to one embodiment, Map6to4 module 316 performs up to 3 hash lookups on the destination address of the IPv6 packet, checking the /96, /64, or /32 prefixes, in that order in one embodiment, and stopping at the first hit, per longest prefix match (LPM) semantics. A MAP hit results in Map6to4 module 316 translating the packet to IPv4 and outputting the packet to FibIPv4 module 308 for IPv4 routing using FIB 326. A MAP miss results in Map6to4 module 316 outputting the packet to FibIPv6 module 318 for normal IPv6 routing. Ip6Output module 320 handles IPv6 packet header rewrites, such as computing checksums, performing DSCP rewrites, or other packet header rewrites.

NextHop receives IPv4 packets (e.g., a first input gate) and receives IPv6 packets (e.g., on a second input gate) and adds information based on the next hop determined by the FibIpv4 module 308 or FibIPv6 module 318, such as the next hop MAC address.

As discussed above, SFE 300 can implement various forms of exception handling for the exception traffic forwarded to it. In one embodiment, SFE 300 performs MTU violation after translation exception handling. According to one embodiment, the network device on which SFE 300 executes performs path MTU discovery (PMTUD) to determine the MTUs of paths in one or more of the networks to which it is connected and can, therefore, set the minimum path MTUs as a threshold for fragmenting. In addition, or in the alternative, the network device provides a configuration function for the network administrator to set MTU thresholds to values that, for example, reflect the real values of the minimum MTUs in the networks or domains.

In particular, in the 4to6 direction the packet size grows (typically by about 20 bytes when translated from IPv4 to IPv6 ) and thus, the translated packet may exceed the MTU size of a MAP domain path. As such, SFE 300 is configured with a threshold MTU for translating to IPv6. For example, in one embodiment, the domain configuration for a MAP domain includes a threshold MTU for IPv6 paths in the MAP domain). In some embodiments, SFE 300 is configured with a threshold MTU for translating to IPv4. For example, in one embodiment, the domain configuration for a MAP domain includes a threshold MTU for IPv4 paths in the MAP domain.

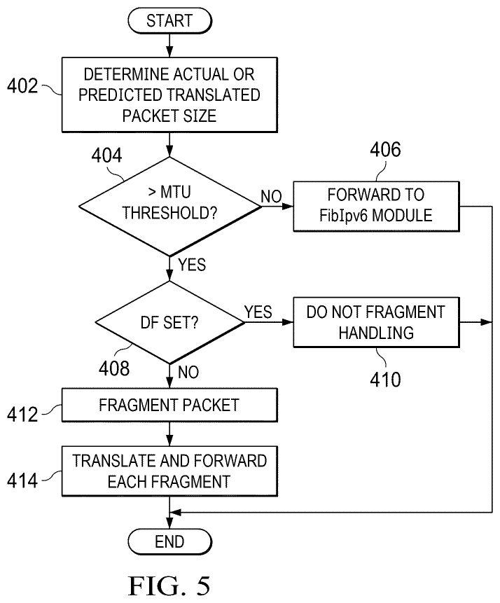

FIG. 5 is a flow chart illustrating one embodiment of a method for exception traffic handling for an MTU violation after translation exception. When Map4to6 module 306 receives an Internet Protocol (IP) packet according to a first version of IP (e.g., IPv4) Map4to6 module 306 determines if the IP packet hits a MAP rule (e.g., a MAP rule in MAP rule set 322).

If the IP packet hits a MAP rule, Map4to6 module 306 determines if the IP packet size as translated to a second version of the IP will exceed a threshold MTU size. For example, Map4to6 module 306 determines if the size of the IP packet as translated exceeds an IPv6 MTU threshold. To determine if the IP packet size as translated to will exceed a threshold MTU size, Map4to6 module 306 determines a translated packet size of the IP packet as translated to the second IP protocol version (step 402). In one embodiment, Map4to6 module 306 performs the 4to6 translation according to the MAP rule matched by the IP packet and determines the actual length of the IP packet as translated to IPv6 . In another embodiment, Map4to6 module 306 reads the length of the received IP packet (e.g., from the packet length header field) and adds the number of bytes that the packet is expected to grow when translated to determine a predicted translated packet size. For example, Map4to6 module 306, in one embodiment, adds 20 bytes (or other expected added length) to the length extracted from the IPv4 IP packet to determine a predicted length of the IP packet after translation to IPv6.

Map4to6 module 306 compares the actual or predicted translated packet size for the IP packet to the MTU threshold to determine if the translated packet size exceeds the MTU threshold (step 404). If the translated packet size (predicted or actual) does not exceed the MTU threshold, Map4to6 module 306 forwards the IP packet to FibIPv6 module 318 for forwarding, translating the packet to IPv6 first according to the matched MAP rule if the packet was not already translated (step 406).

If the translated packet size (predicted or actual) does exceed the threshold MTU, Map4to6 module 306 determines if the “do not fragment” flag (DF) is set in the IPv4 version of the IP packet (step 408). If DF is set, Map4to6 module 306 executes predefined DF handling (step 410).

According to one embodiment of DF handling, Map4to6 module 306 handles the IP packet as if the translated packet size does not exceed the MTU threshold and forwards the packet to FibIpv6 module 318, translating the packet to IPv6 according to the matched MAP rule if the packet has not already been translated. A module further in the pipeline may send back a fragmentation needed if translated packet exceeds link MTU.

According to another embodiment of DF handling, Map4to6 module 306 drops the packet.

In another embodiment of DF handling step 410, Map4to6 module 306 traps the IPv4 packet to the control plane of the network device. According to one embodiment, the control plane (e.g., the operating system or other control plane software), sends a Fragmentation needed packet to the sender of the IPv4 packet that was trapped (e.g., sends an ICMP fragmentation needed packet back).

If the IP packet was not DF marked (DF flag not set in the IPv4 version of the packet), Map4to6 module 306 fragments the IP packet (step 412) resulting in multiple packets. According to one embodiment, Map4to6 module 306 fragments the IP packet according RFC6145 4.1 § 1) (Li, X., Bao, C., & Baker, F. (2011), IP/ICMP translation algorithm (RFC 6145), Internet Engineering Task Force. https://doi.org/10.17487/RFC6145) such that the length of each fragment is at most the MTU minus the additional bytes that will be added in the IPv4 to IPv6 translation and the bytes for the fragment header.

If fragmentation is performed on the IPv4 version of the packet, fragmentation results in multiple IPv4 fragments from the IPv4 packet. Map4to6 module 306 processes each IPv4 fragment resulting from the fragmentation normally, translating each IPv4 fragment to an IPv6 packets according to the MAP rule matched by the received IP packet and forwarding the fragments as translated to FibIpv6 module 318 for routing (step 414).

In another embodiment, Map4to6 module 306 fragments the IP packet after translation. For example, Map4to6 module 306 translates the IP packet from IPv4 to IPv6 (e.g., at step 402 to determine an actual size after translation or at another step prior to fragmentation), fragments the IPv6 version of the IP packet into multiple IPv6 fragments that do not exceed the MTU threshold (step 412) and forwards the IPv6 fragments to FibIpv6 module 318 for routing (step 414).

FIG. 5 is merely provided as an illustrative example. Embodiments may, for example, perform the steps in different orders, omit steps, repeat steps, or perform alternative steps.

Because the IPv4 header is smaller than the IPv6 header, MTU violations after translation are unlikely to occur in the 6To4 direction. However, in some embodiments, Map6to4 module 316 also implements MTU violation after translation exception handling.

In some embodiments, SFE 300 supports defragmentation of IPv4 packets. Defragmentation is implemented, according to one embodiment, by Map4to6 module 306. Post translation, the resulting IPv6 IP packet may exceed the threshold MTU and need to be re-fragmented.

When Map4to6 module 306 receives an IPv4 packet that is a fragment (e.g., MF flag is set to 1 or fragment offset >0) and the IPv4 packet does not match a MAP rule, Map4to6 module 306 outputs the packet to FibIPv4 module 308 for forwarding. On the other hand, if the IPv4 fragment matches a MAP rule, Map4to6 module 306 implements 4to6 IPv4 fragment handling.

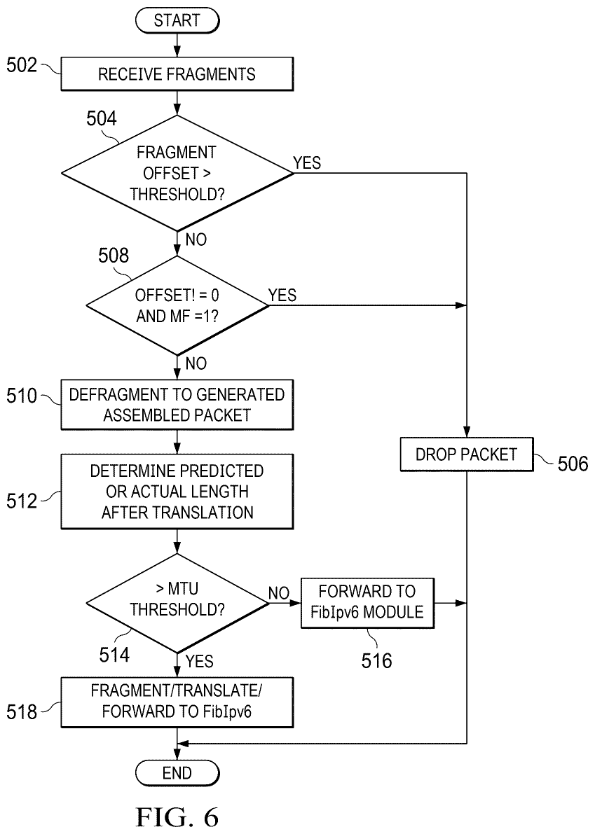

FIG. 6 is a flowchart illustrating one embodiment of a method for 4to6 fragment handling. Map4to6 module 306 receives IPv4 fragments and buffers the IPv4 fragments to be translated until all the related fragments are received (e.g., all the fragments as identified by a unique ID, source address, destination address, protocol field value combination).

In some embodiments, Map4to6 module 306 performs checks on the fragments of a packet to determine if the packet should be dropped. For example, in one embodiment, Map4to6 module 306 determines if the fragment offset of at least one fragment (e.g., the last fragment in the series of fragments of a fragmented packet) is greater than a dropping threshold (step 504). If the fragment offset meets the threshold requirement, Map4to6 module 306 drops the packet (step 506). As one example, the dropping threshold may be set to 1480 because a fragment is >1480 indicates that the sender has their MTU set to >1500, which further indicates that the packet is likely part of a DDoS and should be dropped.

Map4to6 module 306, in one embodiment, determines if any of the fragments of a fragmented packet has a fragment offset not equal to 0 and has an MF flag set to 1 (meaning there are >2 fragments in the series) (step 508), as this is likely DDoS traffic that should be dropped (step 506).

When all the fragments have been received passed the checks, Map4to6 module 306 reassembles the fragments to generate an assembled packet (step 510). According to one embodiment, Map4to6 module 306 uses the ‘rte_ip_frag_table_create’/‘rte_IPv4_frag_reassemble_packet’/‘rte_IPv6 _frag_rea ssemble_packet’ functionality provided by the DPDK library to handle reassembly.

Map4to6 module 306 determines if the translated packet size of the assembled packet exceeds a threshold MTU (e.g., a threshold MTU for the IPv6 network or an MTU threshold associated with the MAP domain of the MAP rule matched by the fragments) (step 512). In one embodiment, Map4to6 module 306 performs the 4to6 translation according to the MAP rule matched by the fragments and determines the actual length of the assembled IP packet as translated to IPv6 . In another embodiment, the Map4to6 module 306 adds the number of bytes that the packet is expected to grow when translated to the length of the assembled IP packet to determine a predicted translated packet size. For example, Map4to6 module 306, in one embodiment, adds 20 bytes (or other expected added length) to the length of the assembled IP packet to determine a predicted length of the assembled IP packet after translation to IPv6.

The mapping module compares the actual or predicted translated packet size for the assembled IP packet to the MTU threshold to determine if the translated packet size exceeds the MTU threshold (step 514). If the translated packet size (predicted or actual) does not exceed the MTU threshold, Map4to6 module 306 forwards the assembled IP packet to FibIPv6 module 318 for forwarding, translating the packet to IPv6 first according to the matched MAP rule if the packet was not already translated (step 516).

In some embodiments, if the actual or predicted length for the translated packet does exceed the MTU threshold, Map4to6 module 306 drops the packet. In another embodiment, Map4to6 module 306 re-fragments the assembled IPv4 packet, translates the IPv4 fragments according to the matched MAP rule and forwards the translated fragments to FibIpv6 module 318 for forwarding (step 518).

In another embodiment, Map4to6 module 306 translates the assembled IPv4 packet (e.g., to determine an actual length at step 512 or otherwise prior to refragmentation) and, at step 518, fragments the translated assembled IP packet and forwards the translated fragments to FibIpv6 module 318 for forwarding.

FIG. 6 is merely provided as an illustrative example. Embodiments may, for example, perform the steps in different orders, omit steps, repeat steps, or perform alternative steps.

In some embodiments, the forwarding chip (e.g., forwarding chip 204) only supports translating certain protocols, but SFE 300 supports at least partially translating one or more protocols that are not supported by the forwarding chip. As such, in some embodiments, the forwarding chip offloads packets containing unsupported protocols to the CPU for processing by SFE 300. For example, a forwarding chip that only supports TCP/UDP may offload non-TCP/UDP traffic, such as ICMP and ICMPv6 traffic among others to the CPU for processing using SFE 300.

In some cases, SFE 300 only supports limited cases within a protocol translation and drops non-supported cases (i.e., packets for which translation cannot be performed). This may include dropping some packets that should be translated according to RFC7915. For example, if SFE 300 only supports translations of Echo requests/replies for ICMP/ICMPv6 translations, SFE 300 drops ICMP/ICMPv6 packets that are not Echo requests/replies. According to one embodiment, Map4to6 module 306 and Map6to4 module 316 are respectively responsible for dropping IPv4 packets and IPv6 packets for unsupported cases. For supported cases, Map4to6 module 306 and Map6to4 module 316 perform the respective translations and forward the translated packets to the appropriate FIB module (FibIPv4 module 308 or FibIPv6 module 318)

In case of an IPv4 UDP packet for translation to IPv6 where the UDP packet has a checksum of 0, some embodiments may insert a non-zero checksum into the packet header. According to one embodiment, Map4to6 module 306 loops over the original IPv4 UDP packet, calculates the checksum, updates the checksum based on changes made to the packet during translation or otherwise and writes the updated checksum in the packet header of the translated packet.

There may be cases, however, where a significant volume of IPv4 UDP traffic has checksum 0 and it may not be desirable to use resources to calculate the checksum for every such packet. In some embodiments UDP Checksum 0 recalculation can be disabled by configuration. The configuration to disable this may be applied to specified MAP domains in some embodiments. If UDP Checksum 0 offload is disabled, the forwarding chip does not treat IPv4 packets with 0 checksum as exceptions and thus, does not forward them to the CPU for exception handling. If UDP Checksum 0 offload is enabled, the forwarding chip forces IPv4 packets with 0 checksum to SFE 300 and Map4to6 module 306 recomputes the checksum.

Some embodiments may be practiced in an electrical circuit comprising discrete electronic elements, packaged or integrated electronic chips containing logic gates, a circuit utilizing a microprocessor, or chip single chip containing electronic elements or microprocessors. For example, examples of computer systems may be practiced via a system-on-a-chip (SOC) where each or many of the components of a computer system may be integrated onto a single integrated circuit. Such an SOC device may include processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment on the single integrated circuit (chip).

The different aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

Portions of the methods described herein may be implemented in suitable software code that may reside within RAM, ROM, a hard drive, or other non-transitory storage medium. Alternatively, the instructions may be stored as software code elements on a data storage array, magnetic tape, floppy diskette, optical storage device, or other appropriate data processing system readable medium or storage device.

In this disclosure, specific embodiments have been described with reference to the accompanying figures. In the above description, numerous details are set forth as examples. It will be understood by those skilled in the art, and having the benefit of this Detailed Description, that one or more embodiments described herein may be practiced without these specific details and that numerous variations or modifications may be possible without departing from the scope of the embodiments. Certain details known to those of ordinary skill in the art may be omitted to avoid obscuring the description.

In the above description of the figures, any component described with regard to a figure, in various embodiments, may be equivalent to one or more like-named components shown and/or described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A network device comprising:
a local central processing unit (CPU);
a plurality of interfaces;
a forwarding chip connected to the plurality of interfaces and the CPU, the forwarding chip configured to offload exception traffic to the local CPU; and
a memory comprising stored software instructions for a software forwarding engine (SFE), the SFE executable by the local CPU to process the exception traffic offloaded by the forwarding chip to generate processed exception traffic and return the processed exception traffic to the forwarding chip for forwarding.

2. The network device of claim 1, wherein:
the plurality of interfaces comprises an IPv4 interface and an IPv6 interface;
the forwarding chip is mapping of address and port using translation (MAP-T) enabled; and
the exception traffic offloaded by the forwarding chip comprises MAP-T exception traffic.

3. The network device of claim 2, wherein the forwarding chip is a programmable application specific integrated circuit (ASIC) for routing and switching of packets.

4. The network device of claim 2, wherein processing the exception traffic offloaded by the forwarding chip comprises:
receiving an IP packet according to a first Internet Protocol (IP) version;
determining that the IP packet matches a MAP rule for a MAP domain;
determining to fragment the IP packet, wherein determining to fragment the IP packet comprises determining that a translated packet size of the IP packet when translated to a second IP version exceeds a maximum transmission unit (MTU) threshold;
generating a plurality of fragments according to the second IP version, wherein generating the plurality of fragments according to the second IP version comprises fragmenting the IP packet; and
determining next hop information for the plurality of fragments, wherein returning the processed exception traffic to the forwarding chip for forwarding comprises returning the plurality of fragments and the next hop information to the forwarding chip.

5. The network device of claim 4, wherein processing the exception traffic offloaded by the forwarding chip further comprises translating the IP packet from the first IP version to the second IP version according to the MAP rule prior to fragmenting the IP packet and wherein the plurality of fragments is generated by fragmenting the IP packet as translated to the second IP version.

6. The network device of claim 4, wherein generating the plurality of fragments according to the second IP version comprises:
translating the plurality of fragments from the first IP version to the second IP version according to the MAP rule.

7. The network device of claim 2, wherein to processing the exception traffic offloaded by the forwarding chip comprises:
receiving a plurality of fragments;
assembling the plurality of fragments into an assembled Internet Protocol (IP) packet according to a first IP version;
translating the assembled IP packet to a second IP version according to a MAP rule; and
determining next hop information for the IP packet, wherein returning the processed exception traffic to the forwarding chip comprises returning the IP packet as translated to the second IP version and the next hop information to the forwarding chip.

8. The network device of claim 2, wherein processing the exception traffic offloaded by the forwarding chip comprises:
receiving a plurality of fragments;
assembling the plurality of fragments into an Internet Protocol (IP) packet according to a first IP version;
determining to fragment the IP packet, wherein determining to fragment the IP packet comprises determining that a translated packet size of the IP packet when translated to a second IP version exceeds a maximum transmission unit (MTU) threshold;
generating a second plurality of fragments according to the second IP version, wherein generating the second plurality of fragments according to the second IP version comprises fragmenting the IP packet; and
determining next hop information for the second plurality of fragments, wherein returning the processed exception traffic to the forwarding chip for forwarding comprises returning the second plurality of fragments and the next hop information to the forwarding chip.

9. The network device of claim 2, wherein processing the exception traffic offloaded by the forwarding chip comprises:
receiving an Internet Protocol (IP) packet according to a first IP version, the IP packet encapsulating a protocol not supported by the forwarding chip;
translating the IP packet to a second IP version, including translating the encapsulated protocol; and
determining next hop information for the IP packet, wherein returning the processed exception traffic to the forwarding chip for forwarding comprises returning the IP packet as translated to the second IP version and the next hop information to the forwarding chip.

10. The network device of claim 2, wherein processing the exception traffic offloaded by the forwarding chip comprises:
receiving an Internet Protocol (IP) packet according to a first IP version and encapsulating a UDP protocol with a UDP checksum of 0;
recalculating the UDP checksum to generate a recalculated UDP checksum; and
translating the IP packet to a second IP version according to a MAP rule, the IP packet as translated to the second IP version including the recalculated UDP checksum.

11. A method for exception offloading comprising:
receiving traffic at a forwarding chip of a network device;
identifying, by the forwarding chip, exception traffic for offloading;
offloading the exception traffic to a local central processing unit (CPU) of the network device;
executing, by the local CPU, a software forwarding engine to process the exception traffic offloaded by the forwarding chip to generate processed exception traffic; and
returning the processed exception traffic to the forwarding chip for forwarding to a destination.

12. The method of claim 11, wherein the exception traffic offloaded by the forwarding
chip comprises mapping of address and port using translation (MAP-T) exception traffic and wherein processing the exception traffic offloaded by the forwarding chip further comprises the local CPU:
receiving an IP packet according to a first Internet Protocol (IP) version;
determining that the IP packet matches a MAP rule for a MAP domain;
determining to fragment the IP packet, wherein determining to fragment the IP packet comprises determining that a translated packet size of the IP packet when translated to a second IP version exceeds a maximum transmission unit (MTU) threshold; and
generating a plurality of fragments according to the second IP version, wherein generating the plurality of fragments according to the second IP version comprises fragmenting the IP packet; and
determining next hop information for the plurality of fragments, wherein returning the processed exception traffic to the forwarding chip for forwarding comprises returning the plurality of fragments and the next hop information to the forwarding chip.

13. The method of claim 12, wherein processing the exception traffic offloaded by the forwarding chip further comprises the local CPU translating the IP packet from the first IP version to the second IP version according to the MAP rule prior to fragmenting the IP packet and wherein the plurality of fragments is generated by fragmenting the IP packet as translated to the second IP version.

14. The method of claim 12, wherein generating the plurality of fragments according to the second IP version comprises:
the local CPU translating the plurality of fragments from the first IP version to the second IP version according to the MAP rule.

15. The method of claim 11, wherein the exception traffic offloaded by the forwarding chip comprises mapping of address and port using translation (MAP-T) exception traffic and wherein processing the exception traffic offloaded by the forwarding chip further comprises the local CPU:
receiving a plurality of fragments;
assembling the plurality of fragments into an assembled Internet Protocol (IP) packet according to a first IP version;
translating the assembled IP packet to a second IP version according to a MAP rule; and
determining next hop information for the IP packet, wherein returning the processed exception traffic to the forwarding chip comprises returning the IP packet as translated to the second IP version and the next hop information to the forwarding chip.

16. The method of claim 11, wherein the exception traffic offloaded by the forwarding chip comprises mapping of address and port using translation (MAP-T) exception traffic and wherein processing the exception traffic offloaded by the forwarding chip further comprises the local CPU:
receiving a plurality of fragments;
assembling the plurality of fragments into an Internet Protocol (IP) packet according to a first IP version;
determining to fragment the IP packet, wherein determining to fragment the IP packet comprises determining that a translated packet size of the IP packet when translated to a second IP version exceeds a maximum transmission unit (MTU) threshold;
generating a second plurality of fragments according to the second IP version, wherein generating the second plurality of fragments according to the second IP version comprises fragmenting the IP packet; and
determining next hop information for the second plurality of fragments, wherein returning the processed exception traffic to the forwarding chip for forwarding comprises returning the second plurality of fragments and the next hop information to the forwarding chip.

17. The method of claim 11, wherein the exception traffic offloaded by the forwarding chip comprises mapping of address and port using translation (MAP-T) exception traffic and wherein processing the exception traffic offloaded by the forwarding chip further comprises the local CPU:
receiving an Internet Protocol (IP) packet according to a first IP version, the IP packet encapsulating a protocol not supported by the forwarding chip;
translating the IP packet to a second IP version, including translating the encapsulated protocol; and
determining next hop information for the IP packet, wherein returning the processed exception traffic to the forwarding chip for forwarding comprises returning the IP packet as translated to the second IP version and the next hop information to the forwarding chip.

18. The method of claim 11, wherein the exception traffic offloaded by the forwarding chip comprises mapping of address and port using translation (MAP-T) exception traffic and wherein processing the exception traffic offloaded by the forwarding chip further comprises the local CPU:
receiving an Internet Protocol (IP) packet according to a first IP version and encapsulating a UDP protocol with a UDP checksum of 0;
recalculating the UDP checksum to generate a recalculated UDP checksum; and
translating the IP packet to a second IP version according to a MAP rule, the IP packet as translated to the second IP version including the recalculated UDP checksum.

19. A non-transitory, computer-readable medium storing thereon computer instructions for a software forwarding engine (SFE), the computer instructions comprising instructions executable by a central processing unit (CPU) to:
receive exception traffic offloaded by a local forwarding chip of a network device;
process the exception traffic offloaded by the local forwarding chip to generate processed exception traffic; and
return the processed exception traffic to the local forwarding chip for forwarding to a destination.

20. The non-transitory, computer-readable medium of claim 19, wherein the exception traffic comprises mapping of address and port using translation (MAP-T) exception traffic and wherein the SFE is executable by the CPU to process at least one of:
a maximum transmission unit (MTU) violation after translation exception to return a plurality of Internet Protocol (IP) fragments generated based on receiving an IP packet according to a first IP version, the plurality of IP fragments formatted according to a second IP version;
a fragment exception to return an assembled IP packet according to the second IP version to the local forwarding chip based on receiving input IP fragments according to the first IP version;
a UDP checksum 0 exception to return an IP packet according to the second IP version with a non-zero UDP checksum to the local forwarding chip based on receiving the IP packet formatted according to the first IP version with a 0 UDP checksum; or
an unsupported protocol exception to translate a case of a protocol not supported by the local forwarding chip from the first IP version to the second IP version.
